(19) United States
(12) Patent Application Publication
(10) Pub. No.: US 2008/0040989 A1
(43) Pub. Date: Feb. 21, 2008

(54) Pipe construction kit for sewer pipeline

(76) Inventor: Ralph Peter Hegler, Bad Kissingen (DE)

Correspondence Address: BARNES & THORNBURG LLP, P.O. BOX 2786, CHICAGO, IL, 60690-2786, US

(21) Appl. No.: 10/598,476

(22) PCT Filed: Feb. 25, 2005
(86) PCT No.: PCT/EP05/01974

§ 371 Date: Aug. 31, 2006

(30) Foreign Application Priority Data
Mar. 3, 2004 (DE) 10 2004 010 307.0

(51) Int. Cl. F16L 11/00

(52) U.S. Cl. 52/169.1; 138/121; 138/178

(57) ABSTRACT

A pipe construction kit for a sewer pipeline comprises several pipes made of plastic, which exhibit a circular cross-section. Between in each case two pipes there is to be arranged a shaft base body made of plastic, exhibiting a central connection section. The connection section exhibits a foot having a supporting surface and, diametrically thereto, a connection element for a shaft. On both sides of the connection section there are formed pipe sections for connection with the pipes. The diameter d of the shaft is significantly smaller than the diameter D of the shaft base body.

### BACKGROUND OF THE INVENTION

1. Field of the Invention

The invention relates to a pipe construction kit for a sewer pipeline.

2. Background Art

For sewer pipelines, namely in particular also rainwater transportation lines, in particular in transport infrastructure engineering, concrete pipes and/or concrete shafts are regularly used. The sewer pipes themselves exhibit nominal widths in the range of 300 mm to 600 mm. The concrete pipes are gradually being replaced by composite pipes made of plastic, because the latter exhibit a plurality of advantages, namely in particular the substantially lower weight and the easier layability resulting therefrom, i.e. the higher laying output.

To be able to attach e.g. sewer pipes with a nominal width of 600 mm to a standard shaft made of concrete, the latter must exhibit a diameter of at least 1000 mm. This results in that said concrete shafts form large, heavy and also correspondingly expensive structures that are accessible. However, for the inspection and flushing of sewer pipelines, large accessible shafts of this kind are not always necessary. Because of the modern flushing apparatuses and inspection cameras available, inspection and flushing shafts with a diameter in the range of 300 mm to 400 mm are basically sufficient.

However, sewer pipes with the large diameters mentioned cannot, in turn, be connected thereto.

### SUMMARY OF THE INVENTION

It is therefore the object of the invention to create a construction kit for sewer pipelines, which enables the use of sewer pipes with a large diameter and of shafts with a small diameter.

According to the invention, this object is achieved by a pipe construction kit for a sewer pipeline, comprising
several pipes, made of plastic, having a circular cross-section,
in each case, a shaft base body having a diameter D to be arranged between two pipes and to be connected with said pipes by means of sockets,
in each case, an inspection and flushing shaft, which has a circular cross-section and a diameter d, to be connected with the shaft base body,
wherein the shaft base body is provided with a central connection section and, on both sides on said connection, pipe sections with a circular cross-section for connection with said pipes,
wherein the connection section is provided with a supporting surface and, diametrically opposite said supporting surface, a connection element for said inspection and flushing shaft,
wherein the diameter D of the shaft base body is larger than the diameter d of the inspection and flushing ,
and
wherein the shaft base body is designed as a composite pipe with a corrugated outer pipe section and an essentially cylindrical inner pipe section.

The core of the invention is that part of the shaft functions is transferred into a shaft base body, which is imbedded into the course of the sewer pipeline, whereby the inspection and flushing shaft itself is only designed as a connection piece to said shaft base body. Herewith it is possible to use a shaft of a relatively small diameter, whereby, particularly for sewer pipelines with a different diameters for the sewer pipes and the shaft base body, there are used uniform inspection and flushing shafts with a standard diameter of 300 mm to 400 mm. The total weight thus becomes very low, which leads to a corresponding reduction of the costs. Manufacture is very simple. The pipe construction kits according to the invention are preferably used for rainwater transportation pipelines.

In an advantageous embodiment, sewage connection pipes can also be connected to the shaft base body.

Further features, advantages and details of the invention result from the following description of an embodiment based on the drawing attached.

### BRIEF DESCRIPTION OF THE DRAWING

FIG. 1 a sewer pipeline with a shaft base body and a shaft,

FIG. 2 a longitudinal view of a shaft base body,

FIG. 3 a cross-section through the shaft base body corresponding to intersection line III-III in FIG. 2,

FIG. 4 a cross-section through the shaft base body with a connected shaft and a sewage connection pipe,

FIG. 5 an alternative to FIG. 4 and

FIG. 6 a shaft base body in an endless embodiment.

### DESCRIPTION OF THE PREFERRED EMBODIMENT

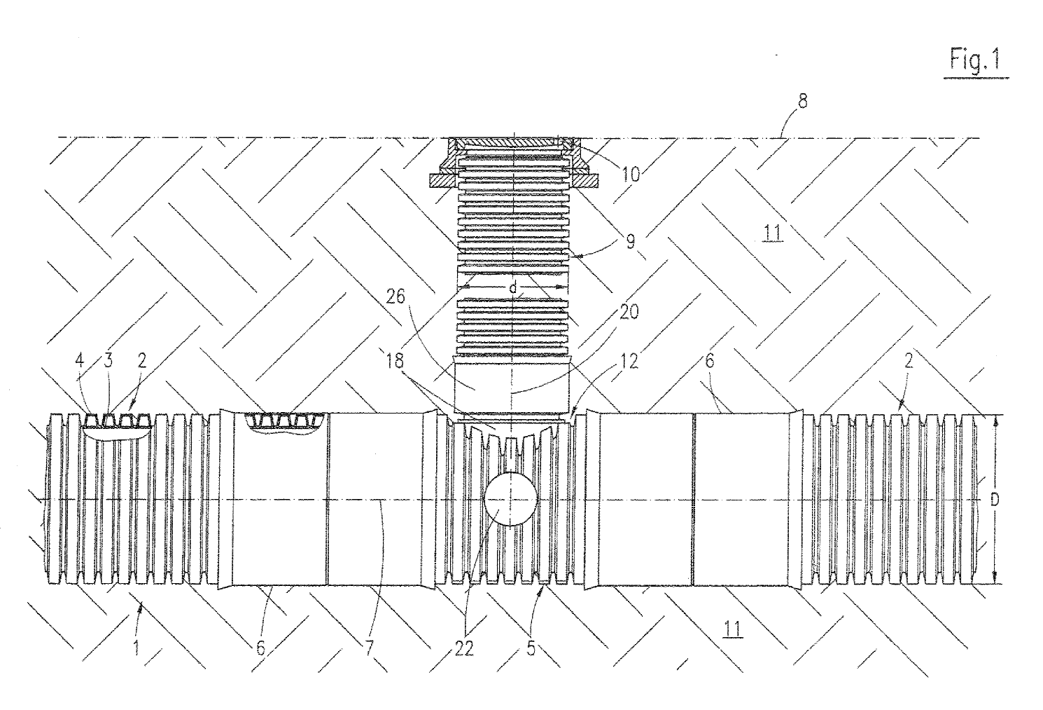

As can be seen from FIG. 1, a sewer transportation line 1 exhibits standard pipes 2 with a circular cross-section, which in the present case—and preferably—are corrugated pipes made of plastic, constructed as composite pipes, i.e. they exhibit an essentially smoothly cylindrical inner pipe 3 and a corrugated outer pipe 4 firmly connected thereto in the manufacturing process. Between two such pipes 2 there is arranged a shaft base body 5 made of plastic, whereby the shaft base body 5 is connected to the pipes 2 by means of double-stab sockets 6 made of plastic, i.e. the shaft base body 5 is arranged in the course of the pipeline 1. Here, the respective end area of the pipes 2 serves as a spigot inserted into the socket 6. Instead of the separate double-stab sockets 6 it is also possible to use sockets manufactured inline, which are integrally formed onto the corresponding pipe 2 or the shaft base body 5. It is also possible to use combinations of socket and spigot, each of which are integrally formed onto the shaft base body 5 in an inline manner. The configuration and manufacture of the pipes 2, including the inline manufacture of such integrally formed sockets or spigots are known, for example, from U.S. Pat. No. 5,320,797, to which reference may be made.

On the shaft base body 5 there is arranged a plastic inspection shaft 9 extending vertically relative to the central longitudinal axis 7 thereof up to the earth's surface 8. Said inspection and flushing shaft 9, which is also designed as a pipe, particularly a composite pipe, i.e. a corrugated pipe, is closed off in the area of the earth's surface 8 by means of a removable cap 10. As the representation of the sewer pipeline 1 laid in the earth with a shaft 9 shows, the diameter D of the pipeline 1 is significantly larger than the diameter d of the shaft 9.

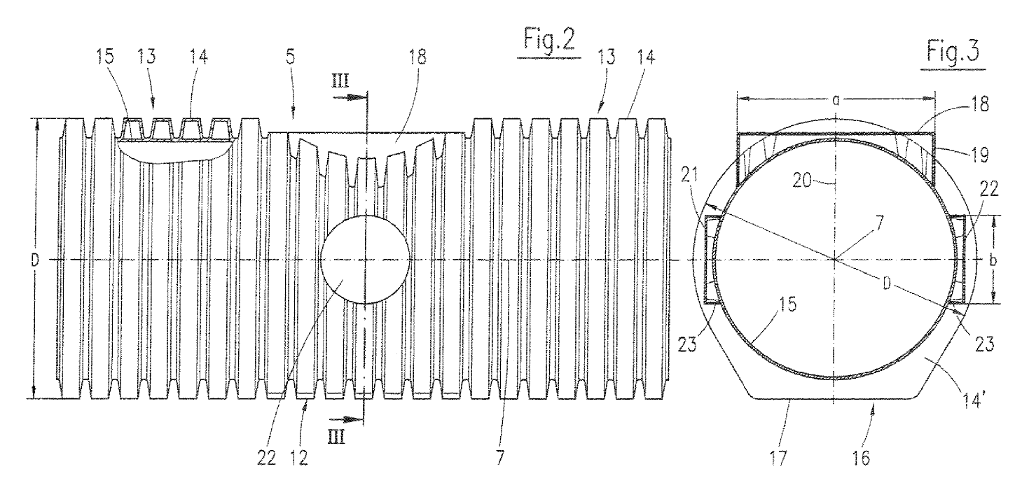

As the illustrations according to FIGS. 2 and 3 show, the shaft base body 5 exhibits a central connection section 12 and, on both sides of said connection section 12, pipe sections 13, which—as already mentioned—also serve as spigots for insertion into the relevant socket 6. The pipe sections are also designed as composite pipe sections, in other words they exhibit an outer pipe section 14 and an essentially smoothly cylindrical inner pipe section 15. The pipe sections 13 have a circular cross-section and exhibit the same diameter D as the pipes 2, so that they can be connected therewith.

The connection section 12 exhibits a foot 16 with a bottom plane supporting surface 17, by means of which the base body 5 rests on the floor of a trench or the like in the earth 11 during the laying, so that it cannot be twisted but has, and retains during the remaining laying work for pipeline 1, a defined position relative to its axis 7. Said foot 16 is only formed in the area of the connection section 12. So, in this area, the connection section 12 has the shape of a horseshoe as results in particular from FIG. 3.

Drainage pipes, i.e. simple single-wall corrugated pipes, having such a shape are known from U.S. Pat. No. 4,930,936. The connection section 12, too, is designed as a composite pipe, in other words a corrugated pipe, whereby the inner pipe section 15 extends over the full length of the connection section 12. In the area of the connection section 12, the outer pipe section 14 of the two pipe sections 13, which exhibits a diameter D, changes into a horseshoe-shaped outer pipe section 14′.

Diametrically opposite the foot 16 and hence the supporting surface 17, in other words on the top side of the connection section 12, there is a shaft connection surface 18 designed as a connection element. Said connection surface 18 is formed from out of the outer pipe 14, i.e. below the connection surface 18, too, the inner pipe section 15 is essentially designed cylindrically. The circular connection surface 18 is connected to the outer pipe section 14 and the inner pipe section 15 via a lateral supporting wall 19. The central longitudinal axis of the connection surface 20 intersects the central longitudinal axis 7 of the pipeline 1. The connection surface 18 protrudes—as FIG. 3 shows—only partly marginally above the outer pipe section 14.

On the sides of the connection section 12, in other words at a right angle to the central longitudinal axis 20, i.e. in the transition area from the outer pipe section 14, which has the shape of a partial circle, into the foot 16, there are feed connection surfaces 21, 22 designed as connection elements, which are also connected, in each case via a supporting wall 23, with the connection section 12 and which are arranged in a common cross-sectional surface area with the connection surface 18. While the diameter a of the shaft connection surface 18 is relatively large, the corresponding diameter b of the feed connection surfaces 21, 22 is relatively small. With respect to the diameter D of the pipes 2, the following applies:

0.1 D≦a≦0.8 D.

In contrast, with respect to diameter b, the following applies:

0.05 D≦b≦0.4 D.

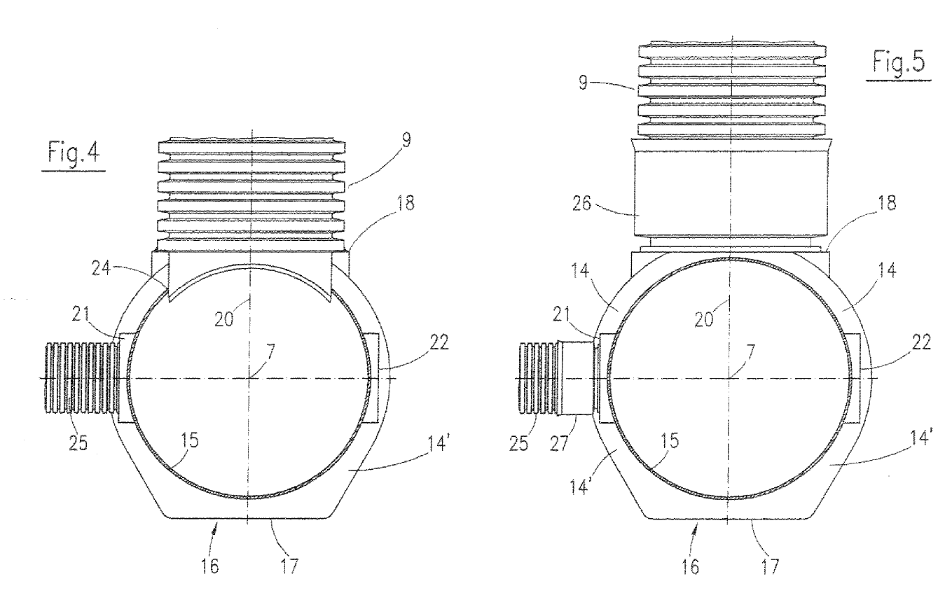

For connecting a shaft 9, there is cut into the shaft connection surface 18, for example by means of a so-called crown drill, an aperture 24 adapted to the shaft 9 to be attached. As is shown in FIG. 4, it is then possible for e.g. a shaft 9 to be fastened to the connection surface 18 by means of welding. In the same way, a sewage connection pipe 25, for example a rainwater feed pipe, can be fastened to one or both feed connection surfaces 21, 22 by means of welding.

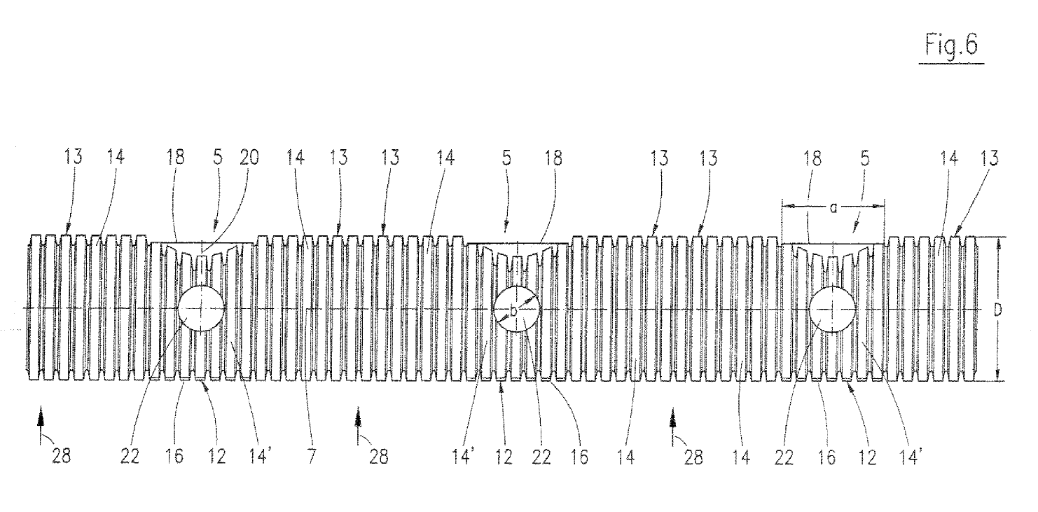

In the case of the alternative according to FIG. 5 there has been attached to the connection surface 18 after the cutting of the aperture 24 a connection nozzle 26, namely also by means of welding. The connection nozzle 26 can also be connected with the shaft connection surface 18 by means of a standard snap-in connection. Into said connection nozzle 26 there is then installed the shaft 9 formed by a pipe. In the same way the sewage connection pipe 25 can also be inserted into a connection nozzle 27, which has previously been fastened to the feed connection surface 21 or 22, also by way of welding or snapping-in.

In FIG. 6 there is indicated how shaft base bodies 5 are continuously manufactured. They are manufactured endlessly, whereby two pipe sections 13 of two neighbouring shaft base bodies 5 abut each other at any one time. Here, the in each case neighbouring connection sections 12 are then in each case separated from one another by means of a parting cut indicated here by an arrow 28. Manufacture of the shaft base bodies 5 takes place in accordance with the above-mentioned method according to U.S. Pat. No. 5,320,797.

What is claimed is:

1. Pipe construction kit for a sewer pipeline (1), comprising
several pipes (2), made of plastic, having a circular cross-section,
in each case, a shaft base body (5) having a diameter D and to be arranged between two pipes (2) and to be connected with said pipes (2) by means of sockets (6),
in each case, an inspection and flushing shaft (9), which has a circular cross-section and a diameter d, to be connected with the shaft base body (5),
wherein the shaft base body (5) is provided with a central connection section (12) and, on both sides on said connection section (12), pipe sections (13) with a circular cross-section for connection with said pipes (2),
wherein the connection section (12) exhibits a supporting surface (17) and, diametrically opposite said supporting surface (17), a connection element (18) for said inspection and flushing shaft (9),
wherein the diameter D of the shaft base body (5) is larger than the diameter d of the inspection and flushing shaft (9),
and
wherein the shaft base body (5) is designed as a composite pipe with a corrugated outer pipe section (14, 14′) and an essentially cylindrical inner pipe section (15).

2. (canceled)

3. Pipe construction kit according to claim 1, wherein for the diameter d of the inspection and flushing shaft (9) the following applies with respect to the diameter D of the shaft base body (5): 0.1 D≦d≦0.8 D.

4. Pipe construction kit according to claim 1, wherein the supporting surface (17) is formed on a foot (16) of the connection section (12).

5. Pipe construction kit according to claim 1, wherein the connection section (12) exhibits approximately a horseshoe cross-section.

6. Pipe construction kit according to claim 1, wherein laterally between the supporting surface (17) and the connection element (18) for the inspection and flushing shaft (9) there is formed at least one connection element (21, 22) for a sewage connection pipe (25).

7. Pipe construction kit according to claim 5, wherein for the diameter b of the at least one connection element (21, 22) for a sewage connection pipe (25) the following applies with respect to the diameter D of the shaft base body (5):
0.05 D≦b≦0.4 D.

8. Pipe construction kit according to claim 1, wherein the connection element for the inspection and flushing shaft (9) is designed as a shaft connection surface (18).

9. Pipe construction kit according to claim 5, wherein the at least one connection element for the sewage connection pipe (25) is designed as a feed connection surface (21, 22).

10. (canceled)

11. Pipe construction kit according to claim 1, wherein the inspection and flushing shaft (9) is designed as a composite pipe with external corrugations.

12. (canceled)

13. Pipe construction kit according to claim 1, wherein a removable cap (10) is provided for closing the inspection and flushing shaft (9).

14. Pipe construction kit according to claim 1, wherein the shaft base body (5) is designed inline.
